(19) United States
(12) Patent Application Publication
(10) Pub. No.: US 2017/0142721 A1
(43) Pub. Date: May 18, 2017

(54) APPARATUS, SYSTEM AND METHOD OF COMMUNICATING OVER A NARROWBAND CHANNEL IN A 2.4 GIGAHERTZ (GHZ) FREQUENCY BAND

(71) Applicant: INTEL CORPORATION, Santa Clara, CA (US)

(72) Inventors: Shahrnaz Azizi, Cupertino, CA (US); Jeffrey R. Foerster, Portland, OR (US); Thomas J. Kenney, Portland, OR (US); Eldad Perahia, Portland, OR (US)

(21) Appl. No.: 15/184,497

(22) Filed: Jun. 16, 2016

Related U.S. Application Data
(60) Provisional application No. 62/254,263, filed on Nov. 12, 2015.

(51) Int. Cl. H04W 72/04; H04W 28/20; H04L 5/00

(52) U.S. Cl. CPC H04W 72/0453; H04L 5/0007; H04W 28/20; H04W 84/12

(57) ABSTRACT

Some demonstrative embodiments may include apparatuses, devices, systems and methods of communicating over a narrowband channel in a 2.4 Gigahertz (GHz) frequency band. For example, wireless device may be configured to generate a frame configured for transmission over a narrow channel bandwidth of between 2 Megahertz (MHz) and 3 MHz; and to transmit the frame over a narrowband channel in a 2.4 GHz frequency band, the narrowband channel having the narrow channel bandwidth.

### CROSS REFERENCE

This application claims the benefit of and priority from U.S. Provisional Patent Application No. 62/254,263 entitled “APPARATUS, SYSTEM AND METHOD OF COMMUNICATION ACCORDING TO A NARROWBAND CHANNELIZATION IN A 2.4 GIGAHERTZ (GHZ) BAND”, filed Nov. 12, 2015, the entire disclosure of which is incorporated herein by reference.

### TECHNICAL FIELD

Embodiments described herein generally relate to communicating over a narrowband channel in a 2.4 Gigahertz (GHz) frequency band.

### BACKGROUND

Some computing devices, for example, small computing devices, such as, for example, wearable devices and/or sensors, are constrained by a small battery capacity.

There is a need to enable improved low power operation of wireless devices, in addition to potentially extending a range of operation of the wireless devices.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a channelization scheme, in accordance with some demonstrative embodiments.

FIG. 3 is a schematic illustration of spectral masks of two channels adjacent to a narrowband channel, in accordance with some demonstrative embodiments.

FIG. 4 is a schematic flow-chart illustration of a method of communicating over a narrowband channel in a 2.4 Gigahertz (GHz) frequency band, in accordance with some demonstrative embodiments.

FIG. 5 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, an Internet of Things (IoT) device, a sensor device, a wearable device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing IEEE 802.11 standards (including IEEE 802.11-2012 (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012); IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec., 2012); IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”); IEEE 802.11ax (IEEE 802.11ax, High Efficiency WLAN (HEW)); IEEE802.11-ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing Wireless Fidelity (WiFi) Alliance (WFA) Peer-to-Peer (P2P) specifications (including WiFi P2P technical specification, version 1.5, Aug. 4, 2014) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, devices and/or networks operating in accordance with existing Bluetooth (BT) specifications and/or protocols and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative embodiments may be used in conjunction with a WLAN, e.g., a WiFi network. Other embodiments may be used in conjunction with any other suitable wireless communication network, for example, a wireless area network, a “piconet”, a WPAN, a WVAN and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

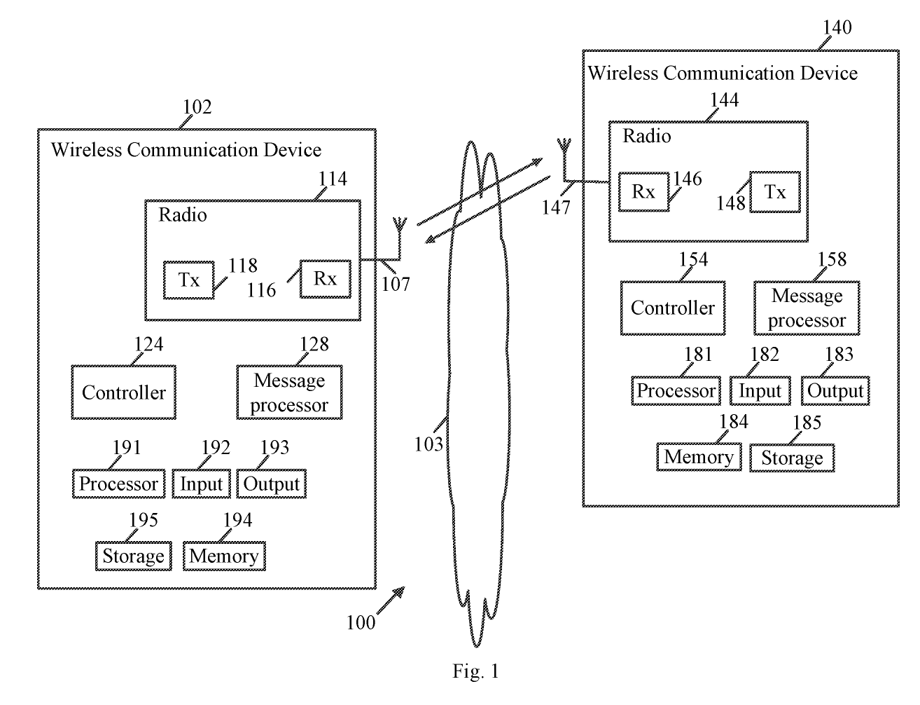

Reference is made to FIG. 1, which schematically illustrates a system 100, in accordance with some demonstrative embodiments.

As shown in FIG. 1, in some demonstrative embodiments, system 100 may include one or more wireless communication devices. For example, system 100 may include a first wireless communication device 102, and/or a second wireless communication device 140.

In some demonstrative embodiments, device 102 and/or device 140 may include a mobile device or a non-mobile, e.g., a static, device. For example, device 102 and/or device 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, sensor device, a wearable device, a BT device, a handheld device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, device 102 and/or device 140 may include, operate as, and/or perform the functionality of one or more STAs. For example, device 102 may include at least one STA, and/or device 140 may include at least one STA.

In some demonstrative embodiments, device 102 and/or device 140 may include, operate as, and/or perform the functionality of one or more WLAN STAs.

In some demonstrative embodiments, device 102 and/or device 140 may include, operate as, and/or perform the functionality of one or more Wi-Fi STAs.

In some demonstrative embodiments, device 102 and/or device 140 may include, operate as, and/or perform the functionality of one or more BT devices.

In some demonstrative embodiments, device 102 and/or device 140 may include, operate as, and/or perform the functionality of one or more Neighbor Awareness Networking (NAN) STAs.

In some demonstrative embodiments, device 102 and/or device 140 may include, operate as, and/or perform the functionality of one or more location measurement STAs.

In some demonstrative embodiments, device 102 and/or device 140 may include, operate as, and/or perform the functionality of any other devices and/or STAs.

In some demonstrative embodiments, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Device 102 and/or device 140 may optionally include other suitable additional or alternative hardware components and/or software components. In some demonstrative embodiments, some or all of the components of one or more of device 102 and/or device 140 may be enclosed in a common housing or packaging, and may be interconnected or operably associated using one or more wired or wireless links. In other embodiments, components of one or more of device 102 and/or device 140 may be distributed among multiple or separate devices.

In some demonstrative embodiments, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 executes instructions, for example, of an Operating System (OS) of device 140 and/or of one or more suitable applications.

In some demonstrative embodiments, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication device 102 and/or device 140 may be capable of communicating content, data, information and/or signals via a wireless medium (WM) 103. In some demonstrative embodiments, wireless medium 103 may include, for example, a radio channel, a cellular channel, an RF channel, a WiFi channel, an IR channel, a Bluetooth (BT) channel, a Global Navigation Satellite System (GNSS) Channel, and the like.

In some demonstrative embodiments, WM 103 may include a channel over a 2.4 Gigahertz (GHz) frequency band, a channel over a 5 GHz frequency band, a channel over a millimeterWave (mmWave) frequency band, e.g., a 60 GHz frequency band, a channel over a sub 1 Gigahertz (S1G) frequency band, and/or any other channel over any other band.

In some demonstrative embodiments, device 102 and/or device 140 may include one or more radios including circuitry and/or logic to perform wireless communication between devices 102, 140 and/or one or more other wireless communication devices. For example, device 102 may include at least one radio 114, and/or device 140 may include at least one radio 144.

In some demonstrative embodiments, radios 114 and/or 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative embodiments, radios 114 and/or 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative embodiments, radio 114, radio 144, transmitter 118, transmitter 148, receiver 116, and/or receiver 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative embodiments, radios 114 and/or 144 may be configured to communicate according to an OFDM scheme. For example, radios 114 and/or 144 may include an OFDM receiver and/or an OFDM transmitter. In other embodiments, radios 114 and/or 144 may be configured to communicate according to any other additional or alternative modulation scheme.

In some demonstrative embodiments, radios 114 and/or 144 may include, or may be associated with, one or more antennas 107 and/or 147, respectively.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative embodiments, controllers 124 and/or 154 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In some demonstrative embodiments, message processors 128 and/or 158 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative embodiments, at least part of the functionality of message processor 128 may be implemented as part of radio 114, and/or at least part of the functionality of message processor 158 may be implemented as part of radio 144.

In some demonstrative embodiments, at least part of the functionality of message processor 128 may be implemented as part of controller 124, and/or at least part of the functionality of message processor 158 may be implemented as part of controller 154.

In other embodiments, the functionality of message processor 128 may be implemented as part of any other element of device 102, and/or the functionality of message processor 158 may be implemented as part of any other element of device 140.

In some demonstrative embodiments, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other embodiments, controller 124, message processor 128 and/or radio 114 may be implemented by one or more additional or alternative elements of device 102.

In some demonstrative embodiments, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other embodiments, controller 154, message processor 158 and/or radio 144 may be implemented by one or more additional or alternative elements of device 140.

In some demonstrative embodiments, device 102 and/or device 140 may include a wearable device, a sensor, small device, a mobile device, and/or any other device, which may be, for example, powered by a battery and/or any other power source having a limited capacity.

In some demonstrative embodiments, device 102 and/or device 140 may include an Internet of Things (IoT) device.

In some demonstrative embodiments, devices 102 and/or 140 may be configured to communicate over one or more narrowband channels, for example, channels with a channel bandwidth of less than 20 Megahertz (MHz), for example, channels with a channel bandwidth of less than 3 MHz, for example, channel with a channel bandwidth of between 2 MHz and 3 MHz, e.g., as described below.

In some demonstrative embodiments, a narrowband channel may include a channel having a bandwidth of about 2 MHz, for example, less than 2.5 MHz, e.g., as described below. In other embodiments, the narrowband channel may have nay other narrow bandwidth, for example, a bandwidth of between 2 MHz and 3 MHz, or any other narrow bandwidth.

In some demonstrative embodiments, devices 102 and/or 140 may be configured to communicate over one or more narrowband channels in a 2.4 GHz frequency band, which may not overlap with one or more other channels, e.g., legacy channels, within the 2.4 GHz frequency band, e.g., as described below.

In some demonstrative embodiments, devices 102 and/or 140 may be configured to communicate over one or more narrowband channels, e.g., including one or more narrowband channels in a 2.4 GHz frequency band, for example, the industrial, scientific and medical (ISM) 2.4 GHz band, e.g., as described below.

In some demonstrative embodiments, the narrowband channels may be configured, for example, to enable at least Long-Range, Low-Power (LRLP) operation, Wake-UP Radio (WUR) operation, Low Power (LP) operation, and/or LP WUR (LP-WUR) operation, for example, a green field mode LRLP and/or any other additional or alternative communication mode, e.g., for IoT devices and/or any other devices.

In some demonstrative embodiments, devices 102 and/or 140 may be configured to operate as LP, WUR, LP-WUR, and/or LRLP devices, e.g., as described below.

In some demonstrative embodiments, device 102 and/or device 140 may include an LP, WUR, LP-WUR, and/or LRLP device, e.g., as described below.

In some demonstrative embodiments, a channelization of the narrowband channels may be configured, for example, to address a potential technical problem of coexistence of LP, WUR, LP-WUR, and/or LRLP devices with legacy devices, e.g., devices operating in accordance with one or more IEEE 802.11-2012 Standards and/or any other “legacy” standards in the 2.4 GHz band.

In some demonstrative embodiments, the channelization of the narrowband channels may be configured, for example, to evade a legacy coexistence problem, for example, by defining narrowband channels, e.g., channels with a bandwidth of between 2-3 MHz, among, but non-overlapping, existing channels in the 2.4 GHz band, e.g., channels according to the IEEE 802.11b, IEEE 802.11g and/or IEEE 802.11n Standards (“the 11b/11g channels”).

In some demonstrative embodiments, the channelization of the narrowband channels may be configured, for example, to enable at least improved low power operation for wireless devices, e.g., WiFi devices, for example, in addition to potentially extending the range of operation for the wireless devices.

Some demonstrative embodiments may be configured to address coexistence issues with the legacy devices, which may not have been a factor in other standards, for example, the IEEE 802.11ah Standard.

In some demonstrative embodiments, it may be beneficial to enable LP, WUR, LP-WUR, and/or LRLP operation for IoT devices having a bandwidth less than 20 MHz.

In opposed to operation in accordance with Orthogonal Frequency-Division Multiple Access (OFDMA) mechanisms, e.g., according to an IEEE 802.11ax Standard, which allows an option of narrow bandwidths, it may be desired, e.g., for LP, WUR, LP-WUR, and/or LRLP operation, to enable communication of devices that only operate with a narrow bandwidth, for example, a bandwidth of less then 20 MHz, e.g., a bandwidth of less then 3 MHz.

In some demonstrative embodiments, the 2 MHZ bandwidth may be based on a 26-tone OFDMA allocation, e.g., in accordance with an allocation in an IEEE 802.11ax Standard.

In some demonstrative embodiments, LP, WUR, LP-WUR, and/or LRLP devices may potentially only have the ability to communicate, e.g., to transmit (Tx) and/or to receive (Rx), over a narrowband channel, for example, a 2 MHz channel, and/or a channel having any other bandwidth narrower than 20 MHz, e.g., a channel having a narrow bandwidth, which is equal to or greater the 2 MHz and equal to or less than 3 MHz.

The communication over the narrowband channel imposed on the LP, WUR, LP-WUR, and/or LRLP devices may be a paradigm shift in use case. For example, today in Wi-Fi, specifically in the 2.4 GHz band, there are no narrowband channels defined where a device may operate using a fully narrowband transmitter or receiver. Amendments to the IEEE 802.11 Specifications have introduced wider channel bandwidths of 20/40/80 GHZ and 160 GHZ, and increasing bandwidths have been adopted with later releases, with a goal to increase data rates to a device.

In some demonstrative embodiments, communication over the narrowband channel for LP, WUR, LP-WUR, and/or LRLP devices, a requirement for coexistence with legacy devices in a Basic Service Set (BSS) and/or an Overlapping Basic Service Set (OBSS) may create one or more challenging design constraints.

In one example, no carrier sensing may be performed by LP, WUR, LP-WUR, and/or LRLP non-Access Point (AP) STAs. Instead, a trigger frame may be transmitted by an AP to restrict uplink (UL) channel access of LP, WUR, LP-WUR, and/or LRLP devices. However, transmission of the trigger frame may not solve the issue of coexistence. Accordingly, mechanisms to allow the LRLP devices to coexist with legacy devices are required. Specifically, in opposed to devices operating in accordance with an IEEE 802.11ax Standard, where all devices are required to first transmit a legacy preamble over a channel of at least 20 MHz, the LRLP devices may not be able to transmit a 20 MHz, or larger, legacy preamble.

In some demonstrative embodiments, a channelization of narrowband channels, e.g., channels with a bandwidth of 2-3 MHz, may be configured, for example, to at least solve the coexistence problem, for example, by defining narrowband channels among existing channels, e.g., legacy channels in accordance with an IEEE 802.11 Standard, for example, in a non-overlapping manner, e.g., as described below.

In some demonstrative embodiments, devices 102 and 140 may be configured to communicate over the narrowband channels in the 2.4 GHz frequency band, e.g., as described below.

In some demonstrative embodiments, device 102 may be configured to generate and transmit frames for communication over the narrowband channels in the 2.4 GHz frequency band, e.g., as described below

In some demonstrative embodiments, controller 124 may cause, trigger and/or control device 102 and/or message generator 128 to generate a frame configured for transmission over a narrow channel bandwidth of between 2 Megahertz (MHz) and 3 MHz, e.g., a channel having a narrow bandwidth, which is equal to or greater the 2 MHz and equal to or less than 3 MHz.

In some demonstrative embodiments, controller 124 may cause, trigger and/or control device 102 and/or transmitter 118 to transmit the frame over a narrowband channel in the 2.4 GHz frequency band.

In some demonstrative embodiments, the narrowband channel may have the narrow channel bandwidth.

In some demonstrative embodiments, device 140 may be configured to receive and process the frame over the narrowband channel, e.g., as described below.

In some demonstrative embodiments, controller 154 may cause, trigger and/or control device 140 and/or receiver 146 to detect the frame over the narrowband channel in the 2.4 GHz frequency band.

In some demonstrative embodiments, controller 154 may cause, trigger and/or control device 140 and/or message processor 158 to process reception of the frame over the narrowband channel.

In some demonstrative embodiments, the frame may include a Greenfield format frame, e.g., as described below.

In some demonstrative embodiments, the frame may include an Orthogonal Frequency Division Multiple Access (OFDMA) frame, e.g., as described below.

In some demonstrative embodiments, the narrowband channel may have no overlap with any Wireless Local Area Network (WLAN) channel in the 2.4 GHz frequency band having a channel bandwidth of at least 20 MHz, e.g., as described below.

In some demonstrative embodiments, the narrowband channel may be in a gap between two non-overlapping WLAN channels in the 2.4 GHz frequency band. For example, each of the two non-overlapping WLAN channels may have a channel bandwidth of at least 20 MHz, e.g., as described below.

In one example, the two non-overlapping WLAN channels may have a channel bandwidth of 20 MHz, 40 MHz, 80 Mhz or 160 Mhz, e.g., for an implementation of IEEE802.11g/11n channels, and a channel bandwidth of 22 MHz, e.g., for an implementation of IEEE802.11b channels.

In some demonstrative embodiments, the narrowband channel may have a channel bandwidth of between 2 MHz and 2.5 MHz, for example, a narrow bandwidth, which is equal to or greater the 2 MHz and equal to or less than 2.5 MHz, e.g., as described below.

In some demonstrative embodiments, the narrowband channel may have a center frequency of 2.4245 GHz, e.g., as described below.

In some demonstrative embodiments, the narrowband channel may have a center frequency of 2.4495 GHz, e.g., as described below.

In other embodiments, the narrowband channel may have any other center frequency.

In some demonstrative embodiments, the narrowband channel may have a bandwidth, which is based on a bandwidth of an OFDMA Resource Unit (RU) including 26 tones, for example, 26 data and/or pilot tones, e.g., 24 data tones and two pilot tones, of a 20 MHz frequency channel including 256 tones, e.g., as described below.

In some demonstrative embodiments, the narrowband channel may include at least 26 frequency subcarriers, e.g., as described below. In other embodiments, the narrowband channel may include any other number of frequency subcarriers, and/or may be configured in accordance with any other frame format.

In some demonstrative embodiments, the frame may include 26 non-zero subcarriers, for example, 24 data subcarriers and two pilot subcarriers, and one or more Direct current (DC) subcarriers, e.g., as described below.

In some demonstrative embodiments, the narrowband channel may have a channel bandwidth of at least 2.03125 MHz, e.g., as described below.

In some demonstrative embodiments, the narrowband channel may have a channel bandwidth of 2.03125 MHz, 2.109375 MHz, 2.265625 MHz, or 2.421875 MHz, e.g., as described below. In other embodiments, the narrowband channel may have any other channel bandwidth.

In some demonstrative embodiments, the narrowband channel may be configured for a frame including 26 non-zero data/pilot subcarriers, e.g., 24 data subcarriers and two pilot subcarriers, and no DC subcarrier.

For example, the narrow bandwidth channel may have a bandwidth of 20 MHz*[(26)/256)]=2.03125 MHz.

In some demonstrative embodiments, the narrowband channel may be configured for a frame including 26 non-zero data/pilot subcarriers and one DC subcarrier.

For example, the narrow bandwidth channel may have a bandwidth of 20 MHz*[(26+1)/256)]=2.109375 MHz.

In some demonstrative embodiments, the narrowband channel may be configured for a frame including 26 non-zero data/pilot subcarriers and three DC subcarriers.

For example, the narrow bandwidth channel may have a bandwidth of 20 MHz*[(26+3)/256)]=2.265625 MHz.

In some demonstrative embodiments, the narrowband channel may be configured for a frame including 26 non-zero data/pilot subcarriers and five DC subcarriers.

For example, the narrow bandwidth channel may have a bandwidth of 20 MHz*[(26+5)/256)]=2.421875 MHz.

In other embodiments, the narrowband channel may be configured for a frame including any other number data subcarriers, pilot subcarriers, DC subcarriers, and/or having any other bandwidth.

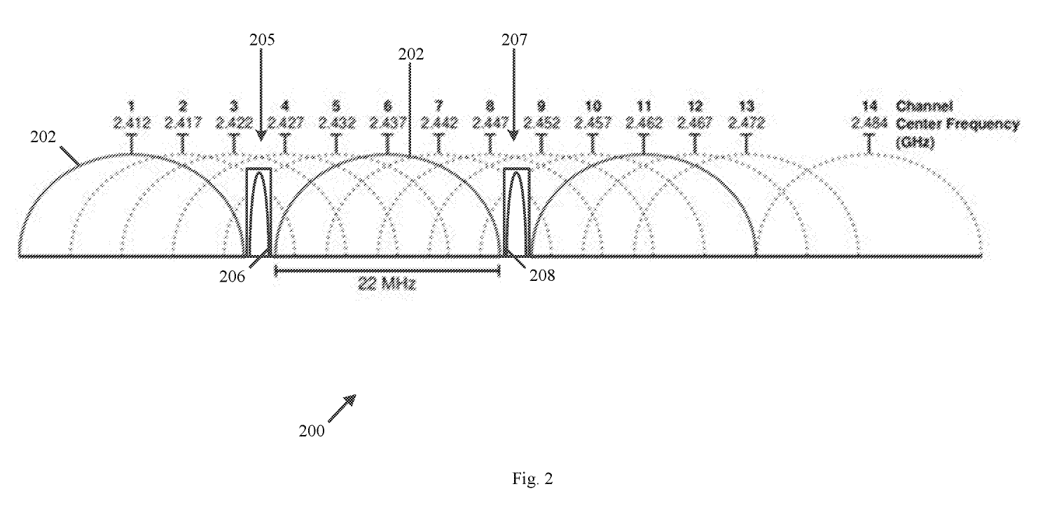

Reference is made to FIG. 2, which schematically illustrates a channelization scheme 200, in accordance with some demonstrative embodiments.

In some demonstrative embodiments, as shown in FIG. 2, channelization scheme 200 may include fourteen existing channels 202, for example, IEEE 802.11g channels in accordance with the IEEE 802.11-2012 Standard.

In some demonstrative embodiments, as shown in FIG. 2, a channel 202 may have a channel bandwidth of 22 MHz.

In some demonstrative embodiments, as shown in FIG. 2, there may be one or more un-assigned spectrums between two or more respective pairs of non-overlapping channels 202.

For example, as shown in FIG. 2, there may be a first unassigned spectrum 205 of 3 MHz between a 22 MHz channel “1” (“Channel 1”) having a center frequency of 2.412 GHz, and a 22 MHz channel “6” (“Channel 6”) having a center frequency of 2.437 GHz.

For example, as shown in FIG. 2, there may be a second unassigned spectrum 207 of 3 MHz between the 22 MHz channel “6” having a center frequency of 2.437 GHz, and a 22 MHz channel “11” (Channel 11”) having a center frequency of 2.462 GHz.

In some demonstrative embodiments, one or more narrowband channels may be defined within the 3 MHz un-assigned spectrum 205 and/or the 3 MHz unassigned spectrum 207.

In some demonstrative embodiments, as shown in FIG. 2, two narrowband channels may be defined. For example, a first narrowband channel 206 may be defined within the 3 MHz unassigned spectrum 205, and/or a second narrowband channel 208 may be defined within the 3 MHz unassigned spectrum 207. In other embodiments, more than two, e.g., three or four channels, may be defined, e.g., by defining two or more narrowband channels in unassigned spectrum 205, and/or by defining two or more narrowband channels in unassigned spectrum 207.

In some demonstrative embodiments, as shown in FIG. 2, narrowband channels 206 and 208 may have a channel bandwidth of less than 3 MHz.

In some demonstrative embodiments, narrowband channels 206 and 208 may have a channel width of 2.03125 MHz.

In some demonstrative embodiments, the channel width of 2.03125 MHz may be in accordance with the bandwidth of a 26-tone OFDMA allocation, e.g., according to an IEEE 802.11ax Specification. However, the channel width is not limited to this bandwidth, but could be any bandwidth, e.g., that is less than 3 MHz.

In some demonstrative embodiments, narrowband channel 206 may be centered at a frequency of 2.4245 GHz.

In some demonstrative embodiments, narrowband channel 208 may be centered at a frequency of 2.4495 GHz.

In some demonstrative embodiments, as shown in FIG. 2, narrowband channels 206 and 208 may have no overlap with the existing 22 MHz channels 202.

Therefore, in some demonstrative embodiments, channelization scheme 200 may enable, for example, a Greenfield operation, for example, for device, e.g., emerging IoT devices, that require reduced throughput with increased range.

In some demonstrative embodiments, the narrowband channels 206 and 208 may, for example, enable the use of dedicated Greenfield operation of future LP, WUR, LP-WUR, and/or LRLP devices.

In some demonstrative embodiments, the narrowband channels 206 and 208 may, for example, enable long range low data rate IoT use cases, for example, by utilizing a bandwidth that is currently not utilized, e.g., in the unassigned spectrums 205 and/or 207.

In one example, the Greenfield operation may enable to perform communication of a frame over the narrowband channel, for example, even without requiring signaling over a wider channel, e.g., one of channels 202, prior to communicating a payload of the frame, or during communication of the payload, for example, to defer or coexist with legacy Wi-Fi systems. Therefore, the Greenfield operation may enable to drastically reduce a preamble overhead. Additionally, implementation of the Greenfield format may enable, for example, a device, e.g., an LP, WUR, LP-WUR, and/or LRLP device, to compete for the narrowband channel, e.g., only with other LP, WUR, LP-WUR, and/or LRLP devices. At least these benefits may provide a huge advantage for creating an efficient waveform and/or efficient MAC, e.g., to address specifically the long range, and/or specifically low power requirements of LP, WUR, LP-WUR, and/or LRLP devices.

In some demonstrative embodiments, the channel width of 2.03125 MHz may support communication of a frame in compliance with a 26-tone OFDMA allocation of an IEEE 802.11ax Specification. Accordingly, implementing a narrowband channel having a channel width of 2.03125 MHz may allow, for example, reuse of a design within OFDMA multiplexing techniques of an IEEE 802.11ax Specification.

In some demonstrative embodiments, at least two formats may be designed for narrowband LP, WUR, LP-WUR, and/or LRLP operation, for example, a Greenfield format and a mixed mode format, e.g., inspired by IEEE 802.11n formats. However, the Greenfield format of the IEEE 802.11n Specification was never adopted in the market due to problems of existence with legacy devices.

In some demonstrative embodiments, the narrowband channels 206 and/or 208 (FIG. 2) may enable to support the Greenfield operation using narrowband channels, e.g., the narrowband channels 206 and/or 208, which may limit, for example, the operation to devices operating only in the narrowband channels, e.g., LP, WUR, LP-WUR, and/or LRLP devices, exclusively.

In some demonstrative embodiments, the mixed mode format may allow for a mix of LP, WUR, LP-WUR, and/or LRLP devices along with other devices, e.g., 802.11ax devices operating within an OFDMA construction.

In some demonstrative embodiments, the deployment issues of IEEE 802.11n may be avoided, for example, by defining dedicated narrowband channels, e.g., the narrowband channels 206 and/or 208, for Greenfield formats, where there is no overlap with legacy operation.

In some demonstrative embodiments, the Greenfield format may be deployed in the dedicated narrowband channels, e.g., narrowband channels 206 and/or 208, and/or the mixed mode format may be deployed in the existing channels of 20 MHz or more, e.g., channels 202, for example, with or without multiplexing with IEEE 802.11ax OFDMA sub-channels.

In some demonstrative embodiments, the narrowband channels defined herein, e.g., the narrowband channels 206 and/or 208, may be used for communication in one or more modes, for example, Greenfield modes, while avoiding legacy coexistence issues, e.g., since no legacy devices operate within the regions 205 and/or 207, in which the narrowband channels are defined.

In some demonstrative embodiments, the narrowband channels defined herein, e.g., the narrowband channels 206 and/or 208, may be implemented for communication, for example, in use cases that require long-range communications, such as, for example, agricultural IoT deployments in rural areas.

It may be difficult to implement the long-range communications over conventional channels, for example, due to the legacy coexistence issues. Legacy devices may be deferred near an AP, which uses 20 MHz legacy preamble transmissions. Range can be extended in a narrowband transmission following the legacy preamble using various methods such as spreading, repetition and so on. However, the legacy preamble reach is fixed, and thus protection beyond that is not possible.

In some demonstrative embodiments, unlike dense urban scenarios, e.g., where multiple channels and frequency multiplexing schemes are desired, the long-range use cases are not densely deployed. Accordingly, in many use cases and/or implementations having on or more, e.g., at least two, dedicated narrowband channels, e.g., narrowband channels 206 and 208, may be sufficient. In contrast, the dense deployments require multiple channels and multiplexing techniques to overcome the interference problems.

In some demonstrative embodiments, the narrowband channels defined herein, e.g., narrowband channels 206 and/or 208, may provide an added benefit of providing long-range use, for example, with no degradation to existing networks, for example, since unused spectrum is utilized, e.g., in the unassigned spectrums 205 and/or 207. The dense deployments may still be allowed utilize existing 20 MHz channels and/or OFDMA sub-channels using mixed mode format, e.g., where the legacy preamble is used to address coexistence.

In some demonstrative embodiments, it is envisioned that such dense deployments likely may not need to support long range, and in cases where there is a need for long range, other methods such as using one or more hop relays, e.g., one or two, or mesh may be possible.

In one example, the mesh type network may be likely the only alternative to achieve a long range. Accordingly, one or more narrowband channels, e.g., narrowband channels 206 and/or 208, may be implemented, for example, to enable long-range communication, e.g., without the overhead and/or deployment complexity of mesh in these use cases in the dense deployments.

In some demonstrative embodiments, one or more narrowband channels, e.g., narrowband channels 206 and/or 208, may be implemented to enable 2 MHz operation in the ISM 2.4 GHz band.

In some demonstrative embodiments, one or more narrowband channels, e.g., narrowband channels 206 and/or 208, may be implemented, for example, to enable narrowband transmission and reception, for example, in the Greenfield format mode, for example, in a way, which may at least solve the legacy coexistence problems described herein.

In some demonstrative embodiments, a system may be deployed, for example, based on a usage scenario, to use one of the formats, e.g., the Greenfield format or the mixed mode format, which may be configured at an AP. This may enable Greenfield Long-Range, Low-Power (LRLP) operation for IoT devices in the narrowband channels, e.g., without legacy constraint issues.

In some demonstrative embodiments, a single carrier waveform may be utilized for Greenfield LRLP devices, for example, in order to simplify device design and cost. In other embodiments any other waveforms, e.g., an OFDM waveform, may be used.

While some demonstrative embodiments described herein generally refer to a narrowband channel having a channel bandwidth of 2 MHz, the exact bandwidth may be vary roughly about 2 MHz. In one example, a transmitter may select a waveform, out of potentially several less than roughly 2 MHz, for example, based on a desired transmit bandwidth and/or data rate. Once selected, the waveform may be filtered, for example, in order to band-limit the signal to a channel bandwidth, e.g., according to channelization scheme 200, and any spectral mask per user requirement.

In some demonstrative embodiments, one or more spectral mask may be used, for example, to limit a signal to a channel bandwidth, e.g., as described below.

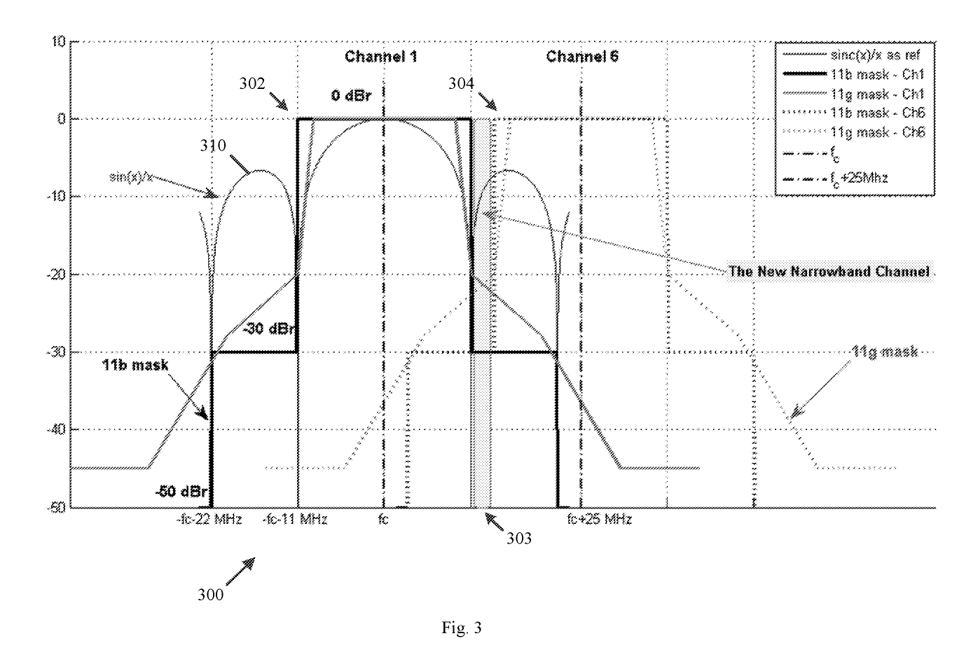

Reference is made to FIG. 3, which schematically illustrates spectral masks of two channels adjacent to a narrowband channel, in accordance with some demonstrative embodiments.

In some demonstrative embodiments, as shown in FIG. 3, first spectral masks 302, e.g., an IEEE 802.11b mask and an IEEE 802.11g mask, may be used to limit a signal 310 for a first channel, e.g., the Channel 1 of FIG. 2.

In some demonstrative embodiments, as shown in FIG. 3, second spectral masks 304, e.g., an IEEE 802.11b mask and an IEEE 802.11g mask, may be used to limit a signal for a second channel, e.g., the Channel 6 of FIG. 2.

In some demonstrative embodiments, as shown in FIG. 3, the Channel 1 may be adjacent to Channel 6.

In some demonstrative embodiments, as shown in FIG. 3, a narrowband channel allocation 303, e.g., the narrowband channel 206 (FIG. 2), may be defined between the Channel 1 and the Channel 6.

In some demonstrative embodiments, as shown in FIG. 3, the narrowband channel allocation 303 may in a 3 MHz gap between the mask 302 of the Channel 1 and a mask 304 of the Channel 6.

In some demonstrative embodiments, the narrowband channel 300 may utilize a channel bandwidth of about 2.03125 MHz, e.g., as described above, for example, to allow compatibility with an IEEE 802.11ax 26-tone OFDMA allocation. However, the channel bandwidth of narrowband channel 303 may be increased, for example, without loss of generality, e.g., as long as the channel bandwidth fits within the 3 MHz gap.

In some demonstrative embodiments, as shown in FIG. 3, spectral masks 302 and 304 may not start to intersect until 20 decibel (dB) down.

In some demonstrative embodiments, as shown in FIG. 3, from 20 dB, masks 302 and 304 decrease across the band. A similar adjacent interference would exist for legacy IEEE 802.11b operation below −30 dBr.

In some demonstrative embodiments, a waveform design for the narrowband channel 303, in accordance with some demonstrative embodiments, may be designed to avoid interference from adjacent Channels 1 and 6. This requirement may be met, for example, by using one or more modulation techniques.

In some demonstrative embodiments, a waveform design for the narrowband channel 303 may be configured as not to interfere with the legacy channels.

In some demonstrative embodiments, one or more requirements for adjacent channels of IEEE 802.1111b/g devices may be met, for example, in order to ensure that the narrowband channel does not to interfere with the legacy channels.

For example, the IEEE 802.11-2012 Specification defines the following adjacent channel requirements for IEEE 802.11b devices:
The adjacent channel rejection shall be equal to or better than 35 dB, with a Frame Error Rate of 0.08 using 11 Mbit/s CCK modulation for a 1024-byte PSDU;
Adjacent channel rejection is defined between any two 11b channels with >=25 MHz separation in each channel group.

For example, the IEEE 802.11-2012 Specification defines the following adjacent channel requirements for IEEE 802.11g devices:
The adjacent channel rejection shall be measured by setting a desired signals strength 3 dB above the rate-dependent sensitivity specified in the Table 1 below and raising the power of the interfering signal until 10% PER is caused for a PSDU length of 1000 octets. The power difference between the interfering and the desired channel is the corresponding adjacent channel rejection. The interfering signal in the adjacent channel shall be a conformant OFDM signal, unsynchronized with the signal in the channel under test. For an OFDM PHY, the corresponding rejection shall be no less than specified in Table 1.

For example, according to the following Table 1, adjacent channels in the 2.4 GHz frequency band may be defined to have a spacing of ±25 MHz:

TABLE 1

| | | | | Minimum | Minimum | Minimum |
|---|---|---|---|---|---|---|
| | | | Alternate | sensitivity | sensitivity | sensitivity |
| | | Adjacent | adjacent | (dBm) | (dBm) | (dBm) |
| | | channel | channel | (20 Mhz | (10 Mhz | (5 Mhz |
| | Coding | rejection | rejection | channel | channel | channel |
| Modulation | rate (R) | (dB) | (dB) | spacing) | spacing) | spacing) |
| BPSK | 1/2 | 16 | 32 | −82 | −85 | −88 |
| BPSK | 3/4 | 15 | 31 | −81 | −84 | −87 |
| QPSK | 1/2 | 13 | 29 | −79 | −82 | −85 |
| QPSK | 3/4 | 11 | 27 | −77 | −80 | −83 |
| 16-QAM | 1/2 | 8 | 24 | −74 | −77 | −80 |
| 16-QAM | 3/4 | 4 | 20 | −70 | −73 | −76 |
| 64-QAM | 2/3 | 0 | 16 | −66 | −69 | −72 |
| 64-QAM | 3/4 | −1 | 15 | −65 | −68 | −71 |

In some demonstrative embodiments, the requirements in Table 1 for adjacent channel rejection may be different from an implementation for a narrowband channel, where a 2 MHz adjacent channel is not an independent IEEE 802.11b/11g signal operating with a separation of 25 MHz.

However, when designing a waveform for the narrowband channel, and/or defining a 2 MHz spectral mask, the requirements in Table 1 may be taken into account, for example, to avoid any adverse impact on legacy operation.

In some demonstrative embodiments, the narrowband channels, e.g., narrowband channels 206 and 208 (FIG. 2), may be different from channels defined for other non-WiFi Specifications, for example, channels defined by a Bluetooth Low Energy (BLE) as “advertising channels”, e.g., according to a Bluetooth Specification.

In one example, the BLE advertising channels may be defined with different center frequencies, may have different bandwidth, and may be configured for a different purpose of operation.

In some demonstrative embodiments, an operation in the narrowband channels defined herein may enable to comply, for example, additional coexistence requirements, for example, a listen before talk procedure, an energy detection procedure, and/or one or more certain co-device coexistence implementations. However, additional coexistence requirements may not prevent operation of Wi-Fi with the narrowband channels.

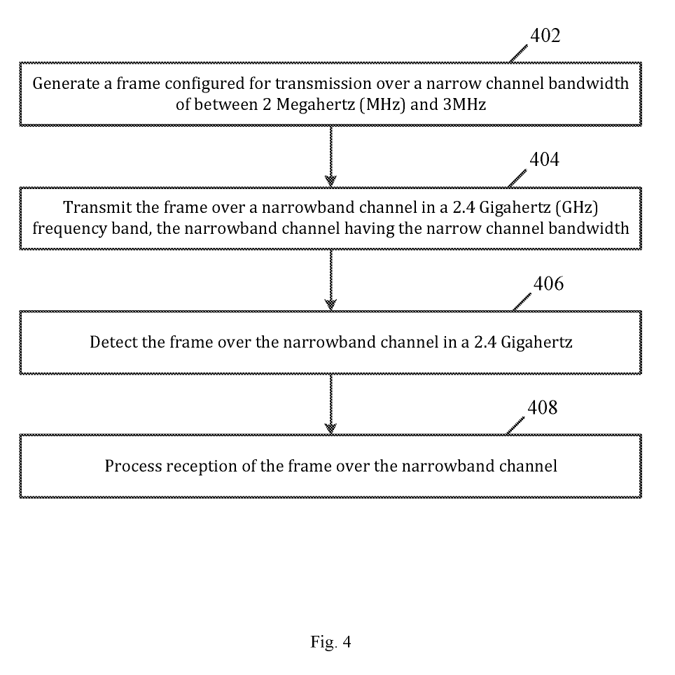

Reference is made to FIG. 4, which schematically illustrates a method of communicating over a narrowband channel in a 2.4 GHz frequency band, in accordance with some demonstrative embodiments. For example, one or more of the operations of the method of FIG. 4 may be performed by one or more elements of a system, e.g., system 100 (FIG. 1), for example, one or more wireless devices, e.g., device 102 (FIG. 1) and/or device 140 (FIG. 1); a controller, e.g., controller 124 (FIG. 1) and/or controller 154 (FIG. 1); a radio, e.g., radio 114 (FIG. 1) and/or radio 144 (FIG. 1); a transmitter, e.g., transmitter 118 and/or transmitter 148 (FIG. 1); a receiver e.g., receiver 116, and/or receiver 146 (FIG. 1); and/or a message processor, e.g., message processor 128 (FIG. 1) and/or message processor 158 (FIG. 1).

As indicated at block 402, the method may include generating at a first wireless device a frame configured for transmission over a narrow channel bandwidth of between 2 MHz and 3 MHz. For example, controller 124 (FIG. 1) may control, cause and/or trigger device 102 (FIG. 1) to generate the frame configured for transmission over the narrow channel bandwidth of between 2 MHz and 3 MHz, e.g., as described above.

As indicated at block 404, the method may include transmitting the frame over a narrowband channel in a 2.4 GHz frequency band, the narrowband channel having the narrow channel bandwidth. For example, controller 124 (FIG. 1) may control, cause and/or trigger device 102 (FIG. 1) to transmit the frame over the narrowband channel having the narrow channel bandwidth in the 2.4 GHz frequency band, e.g., as described above.

As indicated at block 406, the method may include detecting, at a second wireless device, the frame over the narrowband channel in the 2.4 GHz frequency band. For example, controller 154 (FIG. 1) may control, cause and/or trigger device 140 (FIG. 1) to detect the frame over the narrowband channel in the 2.4 GHz frequency band, e.g., as described above.

As indicated at block 408, the method may include processing reception of the frame over the narrowband channel. For example, controller 154 (FIG. 1) may control, cause and/or trigger device 140 (FIG. 1) to process reception of the frame over the narrowband channel, e.g., as described above.

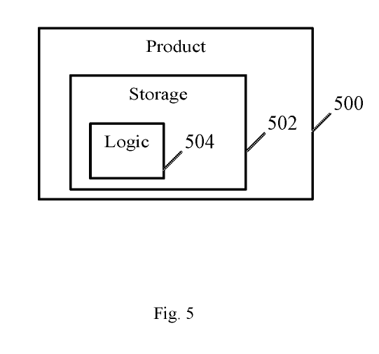

Reference is made to FIG. 5, which schematically illustrates a product of manufacture 500, in accordance with some demonstrative embodiments. Product 500 may include one or more tangible computer-readable non-transitory storage media 502, which may include computer-executable instructions, e.g., implemented by logic 504, operable to, when executed by at least one computer processor, enable the at least one computer processor to implement one or more operations at device 102 (FIG. 1), device 140 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), controller 124 (FIG. 1), controller 154 (FIG. 1), message processor 128 (FIG. 1), and/or message processor 158 (FIG. 1), and/or to perform one or more operations of the method of FIGS. 1, 2, 3, 4, and/or 5, and/or one or more operations described herein. The phrase “non-transitory machine-readable medium” is directed to include all computer-readable media, with the sole exception being a transitory propagating signal.

In some demonstrative embodiments, product 500 and/or machine-readable storage medium 502 may include one or more types of computer-readable storage media capable of storing data, including volatile memory, non-volatile memory, removable or non-removable memory, erasable or non-erasable memory, writeable or re-writeable memory, and the like. For example, machine-readable storage medium 502 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 504 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 504 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes an apparatus comprising circuitry and logic configured to cause a wireless communication device to generate a frame configured for transmission over a narrow channel bandwidth of between 2 Megahertz (MHz) and 3 MHz; and transmit the frame over a narrowband channel in a 2.4 Gigahertz (GHz) frequency band, the narrowband channel having the narrow channel bandwidth.

Example 2 includes the subject matter of Example 1, and optionally, wherein the narrowband channel has no overlap with any Wireless Local Area Network (WLAN) channel in the 2.4 GHz frequency band having a channel bandwidth of at least 20 MHz.

Example 3 includes the subject matter of Example 1 or 2, and optionally, wherein the narrowband channel has a channel bandwidth of between 2 MHz and 2.5 MHz.

Example 4 includes the subject matter of any one of Examples 1-3, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 5 includes the subject matter of any one of Examples 1-4, and optionally, wherein the narrowband channel comprises at least 26 frequency subcarriers.

Example 6 includes the subject matter of Example 5, and optionally, wherein the frame comprises one or more Direct current (DC) subcarriers.

Example 7 includes the subject matter of any one of Examples 1-6, and optionally, wherein the narrowband channel has a channel bandwidth of at least 2.03125 MHz.

Example 8 includes the subject matter of any one of Examples 1-7, and optionally, wherein the narrowband channel has a channel bandwidth of 2.03125 MHz, 2.109375 MHz, 2.265625 MHz, or 2.421875 MHz.

Example 9 includes the subject matter of any one of Examples 1-8, and optionally, wherein the narrowband channel has a center frequency of 2.4245 GHz.

Example 10 includes the subject matter of any one of Examples 1-8, and optionally, wherein the narrowband channel has a center frequency of 2.4495 GHz.

Example 11 includes the subject matter of any one of Examples 1-10, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 12 includes the subject matter of any one of Examples 1-11, and optionally, wherein the frame comprises a Greenfield format.

Example 13 includes the subject matter of any one of Examples 1-12, and optionally, wherein the frame comprises an Orthogonal Frequency Division Multiple Access (OFDMA) frame.

Example 14 includes the subject matter of any one of Examples 1-13, and optionally, wherein the wireless communication device comprises a Long Range Low Power (LRLP) device, or a Wake-Up Receiver (WUR) device.

Example 15 includes the subject matter of any one of Examples 1-14, and optionally, wherein the wireless communication device comprises an Internet of Things (IoT) device.

Example 16 includes the subject matter of any one of Examples 1-15 and optionally, comprising a radio to transmit the frame.

Example 17 includes the subject matter of any one of Examples 1-16 and optionally, comprising one or more antennas, a processor, and a memory.

Example 18 includes a system of wireless communication comprising a wireless communication device, the wireless communication device comprising one or more antennas; a radio; a memory; a processor; and a controller configured to cause the wireless communication device to generate a frame configured for transmission over a narrow channel bandwidth of between 2 Megahertz (MHz) and 3 MHz; and transmit the frame over a narrowband channel in a 2.4 Gigahertz (GHz) frequency band, the narrowband channel having the narrow channel bandwidth.

Example 19 includes the subject matter of Example 18, and optionally, wherein the narrowband channel has no overlap with any Wireless Local Area Network (WLAN) channel in the 2.4 GHz frequency band having a channel bandwidth of at least 20 MHz.

Example 20 includes the subject matter of Example 18 or 19, and optionally, wherein the narrowband channel has a channel bandwidth of between 2 MHz and 2.5 MHz.

Example 21 includes the subject matter of any one of Examples 18-20, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 22 includes the subject matter of any one of Examples 18-21, and optionally, wherein the narrowband channel comprises at least 26 frequency subcarriers.

Example 23 includes the subject matter of Example 22, and optionally, wherein the frame comprises one or more Direct current (DC) subcarriers.

Example 24 includes the subject matter of any one of Examples 18-23, and optionally, wherein the narrowband channel has a channel bandwidth of at least 2.03125 MHz.

Example 25 includes the subject matter of any one of Examples 18-24, and optionally, wherein the narrowband channel has a channel bandwidth of 2.03125 MHz, 2.109375 MHz, 2.265625 MHz, or 2.421875 MHz.

Example 26 includes the subject matter of any one of Examples 18-25, and optionally, wherein the narrowband channel has a center frequency of 2.4245 GHz.

Example 27 includes the subject matter of any one of Examples 18-25 wherein the narrowband channel has a center frequency of 2.4495 GHz.

Example 28 includes the subject matter of any one of Examples 18-27, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 29 includes the subject matter of any one of Examples 18-28, and optionally, wherein the frame comprises a Greenfield format.

Example 30 includes the subject matter of any one of Examples 18-29, and optionally, wherein the frame comprises an Orthogonal Frequency Division Multiple Access (OFDMA) frame.

Example 31 includes the subject matter of any one of Examples 18-30, and optionally, wherein the wireless communication device comprises a Long Range Low Power (LRLP) device, or a Wake-Up Receiver (WUR) device.

Example 32 includes the subject matter of any one of Examples 18-31, and optionally, wherein the wireless communication device comprises an Internet of Things (IoT) device.

Example 33 includes a method to be performed by a wireless communication device, the method comprising generating a frame configured for transmission over a narrow channel bandwidth of between 2 Megahertz (MHz) and 3 MHz; and transmitting the frame over a narrowband channel in a 2.4 Gigahertz (GHz) frequency band, the narrowband channel having the narrow channel bandwidth.

Example 34 includes the subject matter of Example 33, and optionally, wherein the narrowband channel has no overlap with any Wireless Local Area Network (WLAN) channel in the 2.4 GHz frequency band having a channel bandwidth of at least 20 MHz.

Example 35 includes the subject matter of Example 33 or 34, and optionally, wherein the narrowband channel has a channel bandwidth of between 2 MHz and 2.5 MHz.

Example 36 includes the subject matter of any one of Examples 33-35, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 37 includes the subject matter of any one of Examples 33-36, and optionally, wherein the narrowband channel comprises at least 26 frequency subcarriers.

Example 38 includes the subject matter of Example 37, and optionally, wherein the frame comprises one or more Direct current (DC) subcarriers.

Example 39 includes the subject matter of any one of Examples 33-38, and optionally, wherein the narrowband channel has a channel bandwidth of at least 2.03125 MHz.

Example 40 includes the subject matter of any one of Examples 33-39, and optionally, wherein the narrowband channel has a channel bandwidth of 2.03125 MHz, 2.109375 MHz, 2.265625 MHz, or 2.421875 MHz.

Example 41 includes the subject matter of any one of Examples 33-40, and optionally, wherein the narrowband channel has a center frequency of 2.4245 GHz.

Example 42 includes the subject matter of any one of Examples 33-40, and optionally, wherein the narrowband channel has a center frequency of 2.4495 GHz.

Example 43 includes the subject matter of any one of Examples 33-42, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 44 includes the subject matter of any one of Examples 33-43, and optionally, wherein the frame comprises a Greenfield format.

Example 45 includes the subject matter of any one of Examples 33-44, and optionally, wherein the frame comprises an Orthogonal Frequency Division Multiple Access (OFDMA) frame.

Example 46 includes the subject matter of any one of Examples 33-45, and optionally, wherein the wireless communication device comprises a Long Range Low Power (LRLP) device, or a Wake-Up Receiver (WUR) device.

Example 47 includes the subject matter of any one of Examples 33-46, and optionally, wherein the wireless communication device comprises an Internet of Things (IoT) device.

Example 48 includes a product comprising one or more tangible computer-readable non-transitory storage media comprising computer-executable instructions operable to, when executed by at least one computer processor, enable the at least one computer processor to implement operations at a wireless communication device, the operations comprising generating a frame configured for transmission over a narrow channel bandwidth of between 2 Megahertz (MHz) and 3 MHz; and transmitting the frame over a narrowband channel in a 2.4 Gigahertz (GHz) frequency band, the narrowband channel having the narrow channel bandwidth.

Example 49 includes the subject matter of Example 48, and optionally, wherein the narrowband channel has no overlap with any Wireless Local Area Network (WLAN) channel in the 2.4 GHz frequency band having a channel bandwidth of at least 20 MHz.

Example 50 includes the subject matter of Example 48 or 49, and optionally, wherein the narrowband channel has a channel bandwidth of between 2 MHz and 2.5 MHz.

Example 51 includes the subject matter of any one of Examples 48-50, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 52 includes the subject matter of any one of Examples 48-51, and optionally, wherein the narrowband channel comprises at least 26 frequency subcarriers.

Example 53 includes the subject matter of Example 52, and optionally, wherein the frame comprises one or more Direct current (DC) subcarriers.

Example 54 includes the subject matter of any one of Examples 48-53, and optionally, wherein the narrowband channel has a channel bandwidth of at least 2.03125 MHz.

Example 55 includes the subject matter of any one of Examples 48-54, and optionally, wherein the narrowband channel has a channel bandwidth of 2.03125 MHz, 2.109375 MHz, 2.265625 MHz, or 2.421875 MHz.

Example 56 includes the subject matter of any one of Examples 48-55, and optionally, wherein the narrowband channel has a center frequency of 2.4245 GHz.

Example 57 includes the subject matter of any one of Examples 48-55, and optionally, wherein the narrowband channel has a center frequency of 2.4495 GHz.

Example 58 includes the subject matter of any one of Examples 48-57, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 59 includes the subject matter of any one of Examples 48-58, and optionally, wherein the frame comprises a Greenfield format.

Example 60 includes the subject matter of any one of Examples 48-59, and optionally, wherein the frame comprises an Orthogonal Frequency Division Multiple Access (OFDMA) frame.

Example 61 includes the subject matter of any one of Examples 48-60, and optionally, wherein the wireless communication device comprises a Long Range Low Power (LRLP) device, or a Wake-Up Receiver (WUR) device.

Example 62 includes the subject matter of any one of Examples 48-61, and optionally, wherein the wireless communication device comprises an Internet of Things (IoT) device.

Example 63 includes an apparatus of wireless communication by a wireless communication device, the apparatus comprising means for generating a frame configured for transmission over a narrow channel bandwidth of between 2 Megahertz (MHz) and 3 MHz; and means for transmitting the frame over a narrowband channel in a 2.4 Gigahertz (GHz) frequency band, the narrowband channel having the narrow channel bandwidth.

Example 64 includes the subject matter of Example 63, and optionally, wherein the narrowband channel has no overlap with any Wireless Local Area Network (WLAN) channel in the 2.4 GHz frequency band having a channel bandwidth of at least 20 MHz.

Example 65 includes the subject matter of Example 63 or 64, and optionally, wherein the narrowband channel has a channel bandwidth of between 2 MHz and 2.5 MHz.

Example 66 includes the subject matter of any one of Examples 63-65, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 67 includes the subject matter of any one of Examples 63-66, and optionally, wherein the narrowband channel comprises at least 26 frequency subcarriers.

Example 68 includes the subject matter of Example 67, and optionally, wherein the frame comprises one or more Direct current (DC) subcarriers.

Example 69 includes the subject matter of any one of Examples 63-68, and optionally, wherein the narrowband channel has a channel bandwidth of at least 2.03125 MHz.

Example 70 includes the subject matter of any one of Examples 63-69, and optionally, wherein the narrowband channel has a channel bandwidth of 2.03125 MHz, 2.109375 MHz, 2.265625 MHz, or 2.421875 MHz.

Example 71 includes the subject matter of any one of Examples 63-70, and optionally, wherein the narrowband channel has a center frequency of 2.4245 GHz.

Example 72 includes the subject matter of any one of Examples 63-70, and optionally, wherein the narrowband channel has a center frequency of 2.4495 GHz.

Example 73 includes the subject matter of any one of Examples 63-72, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 74 includes the subject matter of any one of Examples 63-73, and optionally, wherein the frame comprises a Greenfield format.

Example 75 includes the subject matter of any one of Examples 63-74, and optionally, wherein the frame comprises an Orthogonal Frequency Division Multiple Access (OFDMA) frame.

Example 76 includes the subject matter of any one of Examples 63-75, and optionally, wherein the wireless communication device comprises a Long Range Low Power (LRLP) device, or a Wake-Up Receiver (WUR) device.

Example 77 includes the subject matter of any one of Examples 63-76, and optionally, wherein the wireless communication device comprises an Internet of Things (IoT) device.

Example 78 includes a apparatus comprising circuitry and logic configured to cause a wireless communication device to detect a frame over a narrowband channel in a 2.4 Gigahertz (GHz) frequency band, the narrowband channel having a narrow channel bandwidth of between 2 Megahertz (MHz) and 3 MHz; and process reception of the frame over the narrowband channel.

Example 79 includes the subject matter of Example 78, and optionally, wherein the narrowband channel has no overlap with any Wireless Local Area Network (WLAN) channel in the 2.4 GHz frequency band having a channel bandwidth of at least 20 MHz.

Example 80 includes the subject matter of Example 78 or 79, and optionally, wherein the narrowband channel has a channel bandwidth of between 2 MHz and 2.5 MHz.

Example 81 includes the subject matter of any one of Examples 78-80, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 82 includes the subject matter of any one of Examples 78-81, and optionally, wherein the narrowband channel comprises at least 26 frequency subcarriers.

Example 83 includes the subject matter of Example 82, and optionally, wherein the frame comprises one or more Direct current (DC) subcarriers.

Example 84 includes the subject matter of any one of Examples 78-83, and optionally, wherein the narrowband channel has a channel bandwidth of at least 2.03125 MHz.

Example 85 includes the subject matter of any one of Examples 78-84, and optionally, wherein the narrowband channel has a channel bandwidth of 2.03125 MHz, 2.109375 MHz, 2.265625 MHz, or 2.421875 MHz.

Example 86 includes the subject matter of any one of Examples 78-85, and optionally, wherein the narrowband channel has a center frequency of 2.4245 GHz.

Example 87 includes the subject matter of any one of Examples 78-85, and optionally, wherein the narrowband channel has a center frequency of 2.4495 GHz.

Example 88 includes the subject matter of any one of Examples 78-87, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 89 includes the subject matter of any one of Examples 78-88, and optionally, wherein the frame comprises a Greenfield format.

Example 90 includes the subject matter of any one of Examples 78-89, and optionally, wherein the frame comprises an Orthogonal Frequency Division Multiple Access (OFDMA) frame.

Example 91 includes the subject matter of any one of Examples 78-90, and optionally, wherein the wireless communication device comprises a Long Range Low Power (LRLP) device, or a Wake-Up Receiver (WUR) device.

Example 92 includes the subject matter of any one of Examples 78-91, and optionally, wherein the wireless communication device comprises an Internet of Things (IoT) device.

Example 93 includes the subject matter of any one of Examples 78-92 and optionally, comprising a radio to receive the frame.

Example 94 includes the subject matter of any one of Examples 79-93 and optionally, comprising one or more antennas, a processor, and a memory.

Example 95 includes a system of wireless communication comprising a wireless communication device, the wireless communication device comprising one or more antennas; a radio; a memory; a processor; and a controller configured to cause the wireless communication device to detect a frame over a narrowband channel in a 2.4 Gigahertz (GHz) frequency band, the narrowband channel having a narrow channel bandwidth of between 2 Megahertz (MHz) and 3 MHz; and process reception of the frame over the narrowband channel.

Example 96 includes the subject matter of Example 95, and optionally, wherein the narrowband channel has no overlap with any Wireless Local Area Network (WLAN) channel in the 2.4 GHz frequency band having a channel bandwidth of at least 20 MHz.

Example 97 includes the subject matter of Example 95 or 96, and optionally, wherein the narrowband channel has a channel bandwidth of between 2 MHz and 2.5 MHz.

Example 98 includes the subject matter of any one of Examples 95-97, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 99 includes the subject matter of any one of Examples 95-98, and optionally, wherein the narrowband channel comprises at least 26 frequency subcarriers.

Example 100 includes the subject matter of Example 99, and optionally, wherein the frame comprises one or more Direct current (DC) subcarriers.

Example 101 includes the subject matter of any one of Examples 95-100, and optionally, wherein the narrowband channel has a channel bandwidth of at least 2.03125 MHz.

Example 102 includes the subject matter of any one of Examples 95-101, and optionally, wherein the narrowband channel has a channel bandwidth of 2.03125 MHz, 2.109375 MHz, 2.265625 MHz, or 2.421875 MHz.

Example 103 includes the subject matter of any one of Examples 95-102, and optionally, wherein the narrowband channel has a center frequency of 2.4245 GHz.

Example 104 includes the subject matter of any one of Examples 95-102 wherein the narrowband channel has a center frequency of 2.4495 GHz.

Example 105 includes the subject matter of any one of Examples 95-104, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 106 includes the subject matter of any one of Examples 95-105, and optionally, wherein the frame comprises a Greenfield format.

Example 107 includes the subject matter of any one of Examples 95-106, and optionally, wherein the frame comprises an Orthogonal Frequency Division Multiple Access (OFDMA) frame.

Example 108 includes the subject matter of any one of Examples 95-107, and optionally, wherein the wireless communication device comprises a Long Range Low Power (LRLP) device, or a Wake-Up Receiver (WUR) device.

Example 109 includes the subject matter of any one of Examples 95-108, and optionally, wherein the wireless communication device comprises an Internet of Things (IoT) device.

Example 110 includes a method to be performed by a wireless communication device, the method comprising detecting a frame over a narrowband channel in a 2.4 Gigahertz (GHz) frequency band, the narrowband channel having a narrow channel bandwidth of between 2 Megahertz (MHz) and 3 MHz; and processing reception of the frame over the narrowband channel.

Example 111 includes the subject matter of Example 110, and optionally, wherein the narrowband channel has no overlap with any Wireless Local Area Network (WLAN) channel in the 2.4 GHz frequency band having a channel bandwidth of at least 20 MHz.

Example 112 includes the subject matter of Example 110 or 111, and optionally, wherein the narrowband channel has a channel bandwidth of between 2 MHz and 2.5 MHz.

Example 113 includes the subject matter of any one of Examples 110-112, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 114 includes the subject matter of any one of Examples 110-113, and optionally, wherein the narrowband channel comprises at least 26 frequency subcarriers.

Example 115 includes the subject matter of Example 114, and optionally, wherein the frame comprises one or more Direct current (DC) subcarriers.

Example 116 includes the subject matter of any one of Examples 110-115, and optionally, wherein the narrowband channel has a channel bandwidth of at least 2.03125 MHz.

Example 117 includes the subject matter of any one of Examples 110-116, and optionally, wherein the narrowband channel has a channel bandwidth of 2.03125 MHz, 2.109375 MHz, 2.265625 MHz, or 2.421875 MHz.

Example 118 includes the subject matter of any one of Examples 110-117, and optionally, wherein the narrowband channel has a center frequency of 2.4245 GHz.

Example 119 includes the subject matter of any one of Examples 110-117, and optionally, wherein the narrowband channel has a center frequency of 2.4495 GHz.

Example 120 includes the subject matter of any one of Examples 110-119, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 121 includes the subject matter of any one of Examples 110-120, and optionally, wherein the frame comprises a Greenfield format.

Example 122 includes the subject matter of any one of Examples 110-121, and optionally, wherein the frame comprises an Orthogonal Frequency Division Multiple Access (OFDMA) frame.

Example 123 includes the subject matter of any one of Examples 110-122, and optionally, wherein the wireless communication device comprises a Long Range Low Power (LRLP) device, or a Wake-Up Receiver (WUR) device.

Example 124 includes the subject matter of any one of Examples 110-123, and optionally, wherein the wireless communication device comprises an Internet of Things (IoT) device.

Example 125 includes a product comprising one or more tangible computer-readable non-transitory storage media comprising computer-executable instructions operable to, when executed by at least one computer processor, enable the at least one computer processor to implement operations at a wireless communication device, the operations comprising detecting a frame over a narrowband channel in a 2.4 Gigahertz (GHz) frequency band, the narrowband channel having a narrow channel bandwidth of between 2 Megahertz (MHz) and 3 MHz; and processing reception of the frame over the narrowband channel.

Example 126 includes the subject matter of Example 125, and optionally, wherein the narrowband channel has no overlap with any Wireless Local Area Network (WLAN) channel in the 2.4 GHz frequency band having a channel bandwidth of at least 20 MHz.

Example 127 includes the subject matter of Example 125 or 126, and optionally, wherein the narrowband channel has a channel bandwidth of between 2 MHz and 2.5 MHz.

Example 128 includes the subject matter of any one of Examples 125-127, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 129 includes the subject matter of any one of Examples 125-128, and optionally, wherein the narrowband channel comprises at least 26 frequency subcarriers.

Example 130 includes the subject matter of Example 129, and optionally, wherein the frame comprises one or more Direct current (DC) subcarriers.

Example 131 includes the subject matter of any one of Examples 125-130, and optionally, wherein the narrowband channel has a channel bandwidth of at least 2.03125 MHz.

Example 132 includes the subject matter of any one of Examples 125-131, and optionally, wherein the narrowband channel has a channel bandwidth of 2.03125 MHz, 2.109375 MHz, 2.265625 MHz, or 2.421875 MHz.

Example 133 includes the subject matter of any one of Examples 125-132, and optionally, wherein the narrowband channel has a center frequency of 2.4245 GHz.

Example 134 includes the subject matter of any one of Examples 125-132, and optionally, wherein the narrowband channel has a center frequency of 2.4495 GHz.

Example 135 includes the subject matter of any one of Examples 125-134, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 136 includes the subject matter of any one of Examples 125-135, and optionally, wherein the frame comprises a Greenfield format.

Example 137 includes the subject matter of any one of Examples 125-136, and optionally, wherein the frame comprises an Orthogonal Frequency Division Multiple Access (OFDMA) frame.

Example 138 includes the subject matter of any one of Examples 125-137, and optionally, wherein the wireless communication device comprises a Long Range Low Power (LRLP) device, or a Wake-Up Receiver (WUR) device.

Example 139 includes the subject matter of any one of Examples 125-138, and optionally, wherein the wireless communication device comprises an Internet of Things (IoT) device.

Example 140 includes an apparatus of wireless communication by a wireless communication device, the apparatus comprising means for detecting a frame over a narrowband channel in a 2.4 Gigahertz (GHz) frequency band, the narrowband channel having a narrow channel bandwidth of between 2 Megahertz (MHz) and 3 MHz; and means for processing reception of the frame over the narrowband channel.

Example 141 includes the subject matter of Example 140, and optionally, wherein the narrowband channel has no overlap with any Wireless Local Area Network (WLAN) channel in the 2.4 GHz frequency band having a channel bandwidth of at least 20 MHz.

Example 142 includes the subject matter of Example 140 or 141, and optionally, wherein the narrowband channel has a channel bandwidth of between 2 MHz and 2.5 MHz.

Example 143 includes the subject matter of any one of Examples 140-142, and optionally, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

Example 144 includes the subject matter of any one of Examples 140-143, and optionally, wherein the narrowband channel comprises at least 26 frequency subcarriers.

Example 145 includes the subject matter of Example 144, and optionally, wherein the frame comprises one or more Direct current (DC) subcarriers.

Example 146 includes the subject matter of any one of Examples 140-145, and optionally, wherein the narrowband channel has a channel bandwidth of at least 2.03125 MHz.

Example 147 includes the subject matter of any one of Examples 140-146, and optionally, wherein the narrowband channel has a channel bandwidth of 2.03125 MHz, 2.109375 MHz, 2.265625 MHz, or 2.421875 MHz.

Example 148 includes the subject matter of any one of Examples 140-147, and optionally, wherein the narrowband channel has a center frequency of 2.4245 GHz.

Example 149 includes the subject matter of any one of Examples 140-147, and optionally, wherein the narrowband channel has a center frequency of 2.4495 GHz.

Example 150 includes the subject matter of any one of Examples 140-149, and optionally, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

Example 151 includes the subject matter of any one of Examples 140-150, and optionally, wherein the frame comprises a Greenfield format.

Example 152 includes the subject matter of any one of Examples 140-151, and optionally, wherein the frame comprises an Orthogonal Frequency Division Multiple Access (OFDMA) frame.

Example 153 includes the subject matter of any one of Examples 140-152, and optionally, wherein the wireless communication device comprises a Long Range Low Power (LRLP) device, or a Wake-Up Receiver (WUR) device.

Example 154 includes the subject matter of any one of Examples 140-153, and optionally, wherein the wireless communication device comprises an Internet of Things (IoT) device.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising circuitry and logic configured to cause a wireless communication device to:
generate a frame configured for transmission over a narrow channel bandwidth of between 2 Megahertz (MHz) and 3 MHz; and
transmit the frame over a narrowband channel in a 2.4 Gigahertz (GHz) frequency band, the narrowband channel having the narrow channel bandwidth.

2. The apparatus of claim 1, wherein the narrowband channel has no overlap with any Wireless Local Area Network (WLAN) channel in the 2.4 GHz frequency band having a channel bandwidth of at least 20 MHz.

3. The apparatus of claim 1, wherein the narrowband channel has a channel bandwidth of between 2 MHz and 2.5 MHz.

4. The apparatus of claim 1, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

5. The apparatus of claim 1, wherein the narrowband channel comprises at least 26 frequency subcarriers.

6. The apparatus of claim 5, wherein the frame comprises one or more Direct current (DC) subcarriers.

7. The apparatus of claim 1, wherein the narrowband channel has a channel bandwidth of at least 2.03125 MHz.

8. The apparatus of claim 1, wherein the narrowband channel has a channel bandwidth of 2.03125 MHz, 2.109375 MHz, 2.265625 MHz, or 2.421875 MHz.

9. The apparatus of claim 1, wherein the narrowband channel has a center frequency of 2.4245 GHz.

10. The apparatus of claim 1, wherein the narrowband channel has a center frequency of 2.4495 GHz.

11. The apparatus of claim 1, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

12. The apparatus of claim 1, wherein the frame comprises a Greenfield format.

13. The apparatus of claim 1, wherein the frame comprises an Orthogonal Frequency Division Multiple Access (OFDMA) frame.

14. The apparatus of claim 1, wherein the wireless communication device comprises a Long Range Low Power (LRLP) device, or a Wake-Up Receiver (WUR) device.

15. The apparatus of claim 1, wherein the wireless communication device comprises an Internet of Things (IoT) device.

16. The apparatus of claim 1 comprising a radio to transmit the frame.

17. The apparatus of claim 1 comprising one or more antennas, a processor, and a memory.

18. A product comprising one or more tangible computer-readable non-transitory storage media comprising computer-executable instructions operable to, when executed by at least one computer processor, enable the at least one computer processor to implement operations at a wireless communication device, the operations comprising:
generating a frame configured for transmission over a narrow channel bandwidth of between 2 Megahertz (MHz) and 3 MHz; and
transmitting the frame over a narrowband channel in a 2.4 Gigahertz (GHz) frequency band, the narrowband channel having the narrow channel bandwidth.

19. The product of claim 18, wherein the narrow channel bandwidth comprises a bandwidth of an Orthogonal Frequency Division Multiple Access (OFDMA) Resource Unit (RU) comprising 26 tones of a 20 MHz frequency channel comprising 256 tones.

20. The product of claim 18, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

21. An apparatus comprising circuitry and logic configured to cause a wireless communication device to:
detect a frame over a narrowband channel in a 2.4 Gigahertz (GHz) frequency band, the narrowband channel having a narrow channel bandwidth of between 2 Megahertz (MHz) and 3 MHz; and
process reception of the frame over the narrowband channel.

22. The apparatus of claim 21, wherein the narrowband channel has no overlap with any Wireless Local Area Network (WLAN) channel in the 2.4 GHz frequency band having a channel bandwidth of at least 20 MHz.

23. The apparatus of claim 21, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.

24. A product comprising one or more tangible computer-readable non-transitory storage media comprising computer-executable instructions operable to, when executed by at least one computer processor, enable the at least one computer processor to implement operations at a wireless communication device, the operations comprising:
detecting a frame over a narrowband channel in a 2.4 Gigahertz (GHz) frequency band, the narrowband channel having a narrow channel bandwidth of between 2 Megahertz (MHz) and 3 MHz; and
processing reception of the frame over the narrowband channel.

25. The product of claim 24, wherein the narrowband channel is in a gap between two non-overlapping Wireless Local Area Network (WLAN) channels in the 2.4 GHz frequency band, each of the two non-overlapping WLAN channels having a channel bandwidth of at least 20 MHz.
